(19) United States
(12) Patent Application Publication
(10) Pub. No.: US 2022/0215254 A1
(43) Pub. Date: Jul. 7, 2022

(54) DEVICE AND METHOD FOR TRAINING THE NEURAL DRIFT NETWORK AND THE NEURAL DIFFUSION NETWORK OF A NEURAL STOCHASTIC DIFFERENTIAL EQUATION

(71) Applicant: Robert Bosch GmbH, Stuttgart (DE)

(72) Inventors: Andreas Look, Kleinsendelbach (DE); Melih Kandemir, Stuttgart (DE)

(21) Appl. No.: 17/646,197

(22) Filed: Dec. 28, 2021

(30) Foreign Application Priority Data
Jan. 5, 2021 (DE) 10 2021 200 042.8

(51) Int. Cl. G06N 3/08; G06N 7/00

(52) U.S. Cl. CPC G06N 3/08; G06N 7/005

(57) ABSTRACT

A method for training the neural drift network and the neural diffusion network of a neural stochastic differential equation. The method includes drawing a training trajectory from training sensor data, and, starting from the training data point which the training trajectory includes for a starting instant, determining the data-point mean and the data-point covariance at the prediction instant for each prediction instant of the sequence of prediction instants using the neural networks. The method also includes determining a dependency of the probability that the data-point distributions of the prediction instants—which are given by the ascertained data-point means and the ascertained data-point covariances—will supply the training data points at the prediction instants, on the weights of the neural drift network and of the neural diffusion network, and adapting the neural drift network and the neural diffusion network to increase the probability.

### CROSS REFERENCE

The present application claims the benefit under 35 U.S.C. § 119 of German Patent Application No. DE 102021200042.8 filed on Jan. 5, 2021, which is expressly incorporated herein by reference in its entirety.

### FIELD

Various exemplary embodiments relate generally to a device and a method for training the neural drift network and the neural diffusion network of a neural stochastic differential equation.

### BACKGROUND INFORMATION

A neural network which has sub-networks that model the drift term and the diffusion term according to a stochastic differential equation is referred to as a neural stochastic differential equation. Such a neural network makes it possible to predict values (e.g., temperature, material properties, speed, etc.) over several time steps, which may be used for a specific control (e.g., of a production process or a vehicle).

### SUMMARY

In order to make accurate predictions, robust training of the neural network, that is, of the two sub-networks (drift network and diffusion network) is necessary. Efficient and stable approaches are desirable for this purpose.

According to various specific embodiments of the present invention, a method is provided for training the neural drift network and the neural diffusion network of a neural stochastic differential equation. The method includes the drawing of a training trajectory from training sensor data, the training trajectory having a training data point for each of a sequence of prediction instants, and—starting from the training data point which the training trajectory includes for a starting instant—determining the data-point mean and the data-point covariance at the prediction instant for each prediction instant of the sequence of prediction instants. This is accomplished by determining from the data-point mean and the data-point covariance of one prediction instant, the data-point mean and the data-point covariance of the next prediction instant by ascertaining the expected values of the derivatives of each layer of the neural drift network according to its input data, ascertaining the expected value of the derivative of the neural drift network according to its input data from the ascertained expected values of the derivatives of the layers of the neural drift network, and ascertaining the data-point mean and the data-point covariance of the next prediction instant from the ascertained expected value of the derivative of the neural drift network according to its input data. The method also includes determining a dependency of the probability that the data-point distributions of the prediction instants—which are given by the ascertained data-point means and the ascertained data-point covariances—will supply the training data points at the prediction instants, on the weights of the neural drift network and of the neural diffusion network, and adapting the neural drift network and the neural diffusion network to increase the probability.

The training method described above permits deterministic training of the neural drift network and the neural diffusion network of a neural stochastic differential equation, (that is, a deterministic inference of the weights of this neural network). In this context, the power of neural stochastic differential equations, their non-linearity, is retained, but a stable training is achieved and as a result, in particular, an efficient and robust provision of accurate predictions even for long sequences of prediction instants, (e.g., for long prediction intervals).

Various exemplary embodiments of the present invention are described in the following.

Exemplary embodiment 1 is a training method as described above.

Exemplary embodiment 2 is the method according to exemplary embodiment 1, whereby the ascertainment from the data-point mean and the data-point covariance of one prediction instant, the data-point mean and the data-point covariance of the next prediction instant features:

Determining, for the prediction instant, the mean and the covariance of the output of each layer of the neural drift network starting from the data-point mean and the data-point covariance of the prediction instant; and

Determining the data-point mean and the data-point covariance of the next prediction instant from the data-point means and data-point covariances of the layers of the neural drift network ascertained for the prediction instant.

Illustratively, according to various specific embodiments, a layer-wise moment matching is carried out. Consequently, the moments may be propagated deterministically through the neural networks, and no sampling is necessary to determine the distributions of the outputs of the neural networks.

Exemplary embodiment 3 is the method according to exemplary embodiment 1 or 2, whereby the ascertainment from the data-point mean and the data-point covariance of one prediction instant, the data-point mean and the data-point covariance of the next prediction instant features:

Determining, for the prediction instant, the mean and the covariance of the output of each layer of the neural diffusion network starting from the data-point mean and the data-point covariance of the prediction instant; and

Determining the data-point mean and the data-point covariance of the next prediction instant from the data-point means and data-point covariances of the layers of the neural diffusion network ascertained for the prediction instant.

In this way, the contribution of the diffusion network to the data-point covariance of the next prediction instant may be ascertained deterministically and efficiently, as well.

Exemplary embodiment 4 is the method according to one of exemplary embodiments 1 through 3, whereby the expected value of the derivative of the neural drift network according to its input data is determined by multiplying the derivatives of the ascertained expected values of the derivatives of the layers of the neural drift network.

This permits exact and simple calculation of the gradients of the complete networks from those of the individual layers.

Exemplary embodiment 5 is the method according to one of exemplary embodiments 1 through 4, whereby determination of the data-point covariance of the next prediction instant from the data-point mean and the data-point covariance of one prediction instant features:

Determining the covariance between input and output of the neural drift network for the prediction instant by multiplying the data-point covariance of the prediction instant by the expected value of the derivative of the neural drift network according to its input data; and

Determining the data-point covariance of the next prediction instant from the covariance between input and output of the neural drift network for the prediction instant.

This procedure permits efficient determination of the covariance between input and output of the neural drift network. This is highly important for the training, since this covariance is not necessarily semi-definite, and an inaccurate determination may lead to numerical instability.

Exemplary embodiment 6 is the method according to one of exemplary embodiments 1 through 5, featuring formation of the neural drift network and the neural diffusion network (only) from ReLU activations, dropout layers and layers for affine transformations.

A construction of the networks from layers of this type permits precise determination of the gradients of the derivatives of the output of the layers according to their inputs without sampling.

Exemplary embodiment 7 is the method according to one of exemplary embodiments 1 through 6, featuring formation of the neural drift network and the neural diffusion network so that the ReLU activations, dropout layers and layers for affine transformations alternate in the neural drift network.

This ensures that the assumption of a normal distribution for the data points is justified and the distribution of a data point at a prediction instant may thus be given with high accuracy by indicating the data-point mean and data-point covariance with respect to the prediction instant.

Exemplary embodiment 8 is the method for controlling a robot device, featuring:

Training of a neural stochastic differential equation in conformity with the method according to one of exemplary embodiments 1 through 7;

Measuring of sensor data which characterize a state of the robot device and/or one or more objects in the area surrounding the robot device;

Supplying the sensor data to the stochastic differential equation to produce a regression result; and

Controlling the robot device utilizing the regression result.

Exemplary embodiment 9 is a training device which is equipped to carry out the method according to one of exemplary embodiments 1 through 7.

Exemplary embodiment 10 is a control device for a robot device, which is equipped to carry out the method according to exemplary embodiment 8.

Exemplary embodiment 11 is a computer program having program instructions which, when executed by one or more processors, prompt the one or more processors to carry out a method according to one of exemplary embodiments 1 through 8.

Exemplary embodiment 12 is a computer-readable storage medium on which program instructions are stored which, when executed by one or more processors, prompt the one or more processors to carry out a method according to one of exemplary embodiments 1 through 8.

Exemplary embodiments of the present invention are represented in the figures and explained in greater detail in the following. In the figures, identical reference numerals everywhere in the various views relate generally to the same parts. The figures are not necessarily true to scale, the focus instead being generally the presentation of the principles of the present invention.

### BRIEF DESCRIPTION OF THE DRAWINGS

FIG. 1 shows an example for a regression in the case of autonomous driving, in accordance with an example embodiment of the present invention.

FIG. 2 illustrates a method for determining the moments of the distribution of data points for one instant from the moments of the distribution of the data points for the previous instant, in accordance with an example embodiment of the present invention.

FIG. 3 shows a flowchart which illustrates a method for training the neural drift network and the neural diffusion network of a neural stochastic differential equation, in accordance with an example embodiment of the present invention.

### DETAILED DESCRIPTION OF EXAMPLE EMBODIMENTS

The various specific embodiments, especially the exemplary embodiments described in the following, may be implemented with the aid of one or more circuits. In one specific embodiment, a “circuit” may be understood to be any type of logic-implementing entity, which may be hardware, software, firmware or a combination thereof. Therefore, in one specific embodiment, a “circuit” may be a hard-wired logic circuit or a programmable logic circuit such as a programmable processor, e.g., a microprocessor. A “circuit” may also be software which is implemented or executed by a processor, e.g., any type of computer program. Any other type of implementation of the respective functions, which are described in greater detail hereinafter, may also be understood to be a “circuit” in accordance with an alternative specific embodiment.

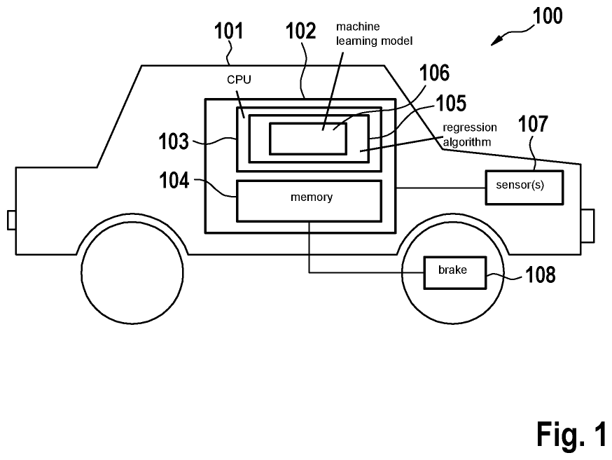

FIG. 1 shows an example for a regression in the case of autonomous driving.

In the example of FIG. 1, a vehicle 101, e.g., an automobile, a delivery truck or a motorcycle, has a vehicle control device 102.

Vehicle control device 102 includes data-processing components, for example, a processor (e.g., a CPU (central processing unit)) 103 and a memory 104 for storing the control software according to which vehicle control device 102 functions, and the data on which processor 103 operates.

In this example, the stored control software has instructions which, when executed by processor 103, prompt the processor to implement a regression algorithm 105.

The data stored in memory 104 may include input sensor data from one or more sensors 107. For example, the one or more sensors 107 may include a sensor which measures the speed of vehicle 101, as well as sensor data which represent the curve of the road (that may be derived, for instance, from image sensor data, which are processed by object detection to determine the direction of travel), the condition of the road, etc. Thus, for example, the sensor data may be multidimensional (curve, road condition, . . . ). The regression result may be one-dimensional, for instance.

Vehicle control 102 processes the sensor data and determines a regression result, e.g., a maximum speed, and is able to control the vehicle on the basis of the regression result. For instance, a brake 108 may be activated if the regression result indicates a maximum speed which is higher than a measured instantaneous speed of vehicle 101.

Regression algorithm 105 may have a machine learning model 106. Machine learning model 106 may be trained utilizing training data in order to make predictions (e.g., a maximum speed).

One widely used model of machine learning is a deep neural network. A deep neural network is trained to implement a function which converts input data (in other words: an input pattern) in non-liner fashion into output data (an output pattern).

According to various specific embodiments, the machine learning model has a neural stochastic differential equation.

A non-linear time-invariant stochastic differential equation (SDE) has the form

dx=f_{θ}(x)dt+L_{ϕ}(x)dw

In this context, f_{θ}(x)∈ [symbol] ^{D} is the drift function which models the deterministic component of the respective vector field, and L_{ϕ}(x)∈ [symbol] ^{D×S} is the diffusion function which models the stochastic component. dt is the time increment and w∈ [symbol] ^{S} denotes a Wiener process.

SDEs are typically not solvable analytically. Numerical approaches to a solution typically utilize a discretization of the time domain and an approximation of the transition in a time step. One possibility for that purpose is the Euler-Maruyama (EM) discretization

\tilde{x}ₖ₊₁^{(θ,ϕ)}=xₖ+f_{θ}(xₖ)Δt+L_{ϕ}(xₖ)Δwₖ

where

Δwₖ˜ [symbol] (0,Δt)

The solution process begins with an initial state x₀, and the final state w_{K} after the last time step is the regression result, for example.

The term “neural stochastic differential equation” relates to the case where f_{θ}(x) and (possibly) L_{ϕ}(x) are given by neural networks (NNs) with weights θ and ϕ, respectively. Even for moderate NN architectures, a neural stochastic differential equation may have many thousand free parameters (i.e., weights) which makes finding the weights from training data, that is, the inference, a challenging task.

In the following, it is assumed that the parameters of a neural stochastic differential equation are found with the aid of Maximum Likelihood Estimation (MLE), that is, by

$${max}_{θ , ϕ} 𝔼 [ log {p}_{θ , ϕ} ( 𝒟 ) ] .$$

This permits the joint learning of θ and ϕ from data. Alternatively, it is also possible to carry out a variation inference, e.g., according to

$${maximize}_{θ} 𝔼 [ log {p}_{θ , ϕ} ( 𝒟 ) - \frac{1}{2} \int {‖ u ( x ) ‖}^{2} dt ]$$

where L_{ϕ}(χ)u(χ)=f_{θ}(χ)−f_{ψ}(χ) and f_{ψ}(χ) is the A-priori drift.

The estimation of the anticipated likelihood is typically not possible analytically. In addition, sampling-based approximations typically lead to an unstable training and result in neural networks with inaccurate predictions.

According to various specific embodiments, these undesirable effects of the sampling are avoided and a deterministic procedure is given for the inference of the weights of the neural networks, which model the drift function and the diffusion function.

According to various specific embodiments, this procedure includes that a numerically tractable process density is used for the modeling, the Wiener process w is marginalized and the uncertainty of the states xₖ is marginalized. The uncertainty in the states comes from (i) the original distribution p(x₀,t₀) as well as from the diffusion term L_{ϕ}(xₖ).

It should be noted that for simplicity, A-priori distributions for the weights of the neural networks are omitted. However, the approaches described may also be used for Bayesian neural networks. Such an A-priori distribution does not necessarily have to be given via the weights, but may also be in the form of a differential equation.

According to various specific embodiments, p(x,t)≈ [symbol] (x|m(t),P(t)) is used as the process distribution, which leads to a Gaussian process approximation with mean and covariance that change over time.

For example, if a time discretization with K steps of an interval [0, T] is used, that is, {tₖ∈[0,T]|k=1, . . . ,K}, then the process variables x₁, . . . , x_{K} (also referred to as states) have the distributions p(x₁,t₁),p(x₂,t₂), . . . ,p(x_{K},t_{K}). The elements of this sequence of distributions may be approximated by recursive moment matching in the forward direction (that is, in the direction of ascending indices).

It is assumed that variable xₖ₊₁ at instant tₖ₊₁ has a Gaussian distribution with density

p_{θ,ϕ}(χₖ₊₁,tₖ₊₁;p_{θ,ϕ}(χₖ,tₖ))≈ [symbol] (χₖ₊₁|mₖ₊₁,Pₖ₊₁)

where the moments mₖ₊₁,Pₖ₊₁ are determined from the already matched moments of the distribution (that is, the density) at the previous instant p_{θ,ϕ}(xₖ, tₖ).

It is assumed that the first two moments of the density at the next instant are equal to the first two moments one EM (Euler-Maruyama} step forward following integration via the state at the current instant:

$${m}_{k + 1} {=}^{Δ} \int {\int }_{{ℝ}^{D \times S}} {\tilde{x}}_{k + 1}^{( θ , ϕ )} \underbrace{{p}_{θ , ϕ} ( {x}_{k} , {t}_{k} )}_{\approx 𝒩 ( {x}_{k} \vert {m}_{k} , {P}_{k} )} p ( {w}_{k} ) {dw}_{k} {dx}_{k} , \\ {P}_{k + 1} {=}^{Δ} \int {\int }_{{ℝ}^{D \times S}} ( {\tilde{x}}_{k + 1}^{( θ , ϕ )} - {m}_{k + 1} ) {( {\tilde{x}}_{k + 1}^{( θ , ϕ )} - {m}_{k + 1} )}^{T} \underbrace{{p}_{θ , ϕ} ( {x}_{k} , {t}_{k} )}_{\approx 𝒩 ( {x}_{k} \vert {m}_{k} , {P}_{k} )} p ( {w}_{k} ) {dw}_{k} {dx}_{k} ,$$

In this case, the dependency on the previous instant is produced by [symbol] (xₖ|mₖ,Pₖ).

It now holds that if \tilde{x}ₖ^{(θ,ϕ)} follows the EM discretization, the updating rules given above for the first two moments satisfy the following analytical form with marginalized Wiener process wₖ:

$${m}_{k + 1} = {\int }_{{ℝ}^{D}} {\hat{x}}_{k + 1}^{( θ , ϕ )} 𝒩 ( {x}_{k} \vert {m}_{k} , {P}_{k} ) {dx}_{k} , \\ {P}_{k + 1} = {\int }_{{ℝ}^{D}} [ ( {\hat{x}}_{k + 1}^{( θ , ϕ )} - {m}_{k + 1} ) {( {\hat{x}}_{k + 1}^{( θ , ϕ )} - {m}_{k + 1} )}^{T} + {L}_{ϕ} {L}_{ϕ}^{T} ( {x}_{k} ) Δ t ⌉ 𝒩 ( {x}_{k} \vert {m}_{k} , {P}_{k} ) {dx}_{k} ,$$

where

\hat{x}ₖ₊₁^{(θ,ϕ)} [symbol] xₖ+f_{θ}(xₖ)Δt

and Δt is a time step that is not dependent on Δwₖ.

In order to obtain a deterministic inference process, in these two equations, it is necessary to integrate via xₖ. Since in the normal case, the integrals are not solvable analytically, numerical approximation is used.

To that end, according to various specific embodiments, the moment matching is expanded to the effect that the two moments mₖ,Pₖ (which clearly reflect the uncertainty in the current state) are propagated through the two neural networks (which model the drift function and the diffusion function). Hereinafter, this is also referred to as Layer-wise Moment Matching (LMM).

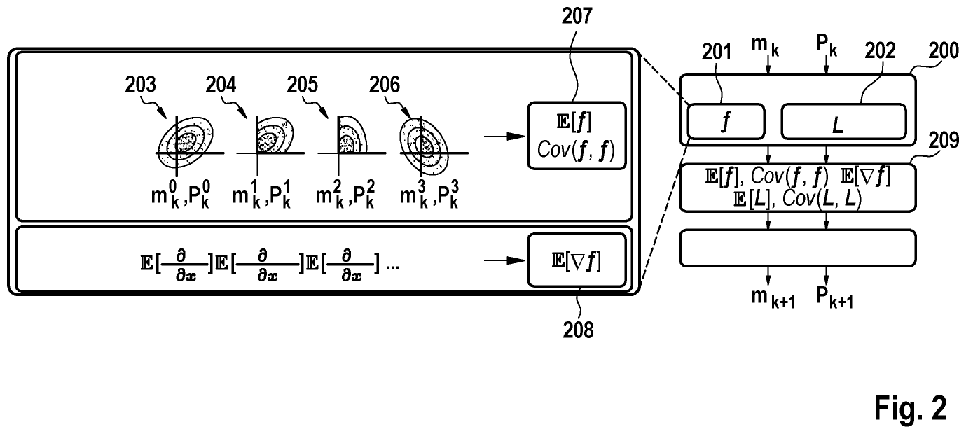

FIG. 2 illustrates a method for determining the moments mₖ₊₁,Pₖ₊₁ for one instant from the moments mₖ,Pₖ for the previous instant.

Neural SDE 200 has a first neural network 201 which models the drift term, and a second neural network 202 which models the diffusion term.

Utilizing the bilinearity of the covariance operation Coli(⋅,⋅), the equations above may be rewritten so that

$${m}_{k + 1} = {m}_{k} + 𝔼 [ {f}_{θ} ( {x}_{k} ) ] Δ t , \\ {P}_{k + 1} = {P}_{k} + Cov ( {f}_{θ} ( {x}_{k} ) , {f}_{θ} ( {x}_{k} ) ) Δ {t}^{2} + ( Cov ( {f}_{θ} ( {x}_{k} ) , {x}_{k} ) + Cov ( {x}_{k} , {f}_{θ} ( {x}_{k} ) ) ) Δ t + 𝔼 [ {L}_{ϕ} {L}_{ϕ}^{T} ( {x}_{k} ) ] Δ t ,$$

where Cov(xₖ,xₖ) is denoted as Pₖ. The central moment of the diffusion term [symbol] [L_{ϕ}L_{ϕ}^{T}(xₖ)] may be estimated with the aid of LMM, if it is diagonal. However (except in trivial cases), the cross covariance Cov(f_{θ}(xₖ),xₖ) cannot be estimated utilizing customary LMM techniques. It is not guaranteed that it is positive-semidefinite, and therefore may lead to an inaccurate estimation that Pₖ₊₁ becomes singular, which adversely affects the numerical stability.

In the following, the output of the 1st layer of a neural network 201, 202 is denoted by x^{l}∈ [symbol] ^{D}^{ₗ}. This output (according to the LMM procedure) is modeled as a multivariate Gaussian distribution with mean m^{l} and covariance P^{l}. The index l=0 is used for the input to the first layer of (respective) neural network 201, 202.

In order to make LMM usable, the critical term Cov(f_{θ}(xₖ),xₖ) is reformulated. This is accomplished by utilizing the lemma of Stein, with whose aid this term may be written as

Cov(f_{θ}(xₖ),xₖ)=Cov(xₖ,xₓ) [symbol] [∇ₓf_{θ}(x)]

The problem is thereby reduced to the ascertainment of an expected value concerning the gradient of neural network 201 [symbol] [∇ₓg(x)], where g=f_{θ}. (The term “gradient” is used here, even if f_{θ} is typically vector-valued, and consequently ∇ₓf_{θ} has the form of a matrix, that is, is a Jacobian matrix; therefore, generally the term “derivative” is simply used, as well.)

In a neural network, the function g(x) is an interlinking of L functions (one per layer of the neural network), that is,

g(x)=g^{L}ºg^{L-1}º . . . g²ºg¹(x)

For suitable layers, it holds that

$$\begin{matrix}𝔼 [ {∇}_{x} g ( x ) ] = & 𝔼 [ \frac{\partial {g}^{L}}{\partial {x}^{L - 1}} \frac{\partial {g}^{L - 1}}{\partial {x}^{L - 2}} … \frac{\partial {g}^{2}}{\partial {x}^{1}} \frac{\partial {g}^{1}}{\partial {x}^{0}} ] \\ = & {𝔼}_{{x}^{L - 1}} [ \frac{\partial {g}^{L}}{\partial {x}^{L - 1}} {𝔼}_{{x}^{L - 2}} [ \frac{\partial {g}^{L - 1}}{\partial {x}^{L - 2}} … \\ & {𝔼}_{{x}^{1}} [ \frac{\partial {g}^{2}}{\partial {x}^{1}} {𝔼}_{{x}^{0}} [ \frac{\partial {g}^{1}}{\partial {x}^{0}} ] ] … ] ] .\end{matrix}$$

In order to determine this interleaving of expected values, the distribution of x^{l}, denoted as p(x^{l}), is assumed as a Gaussian distribution. The intermediate results p(x^{l}) are used for determining m^{L} and P^{L}. Subsequently, the anticipated gradient of each layer in relation to a normal distribution is determined by forward-mode differentiation. According to one specific embodiment, affine transformation, ReLU activation and dropout are used as suitable functions g^{l}, for which m^{l} and P^{l} may be estimated in the case of a normally distributed input, and the anticipated gradient [symbol] _{χ}_{^{l−1}}[∂g^{l}/∂χ^{l}−1] may be determined. Further types of functions or NN layers may also be utilized.

An affine transformation maps an input x^{l} onto an output x^{l+1}∈ [symbol] ^{D}^{₁₊₁} according to Ax^{l}+b with weight matrix A∈ [symbol] ^{D}^{₁₊₁}^{×D}^{ₗ} and bias b∈ [symbol] ^{D}^{ₗ₊₁}. If the input is Gaussian-distributed, the output is also Gaussian-distributed with the moments,

m^{l+1}=Am^{l}+b,

p^{l+1}=AP^{l}A^{T}

and anticipated gradient [symbol] ₓ_{^{l}}[∂g^{l+1}/∂χ^{l}]=A.

The output of a ReLU activation of an input x^{l} is x^{l+1}=max(0,x^{l}). Because of the non-linearity of the ReLU activation, the output in the case of a Gaussian-distributed input is generally not Gaussian-distributed, but its moments may be estimated as

m^{l+1}=\sqrt{diag(P^{l})}SR(m^{l}/\sqrt{diag(P^{l})}),

P^{l+1}=\sqrt{diag(P^{l})}\sqrt{diag(P^{l})}^{T}F(m^{l},P^{l}),

where

SR(μ^{l})=(ϕ(μ^{l})+μ^{l}Φ(μ^{l}))

with ϕ and Φ denoting the density and cumulative distribution function [of] a standard, normally distributed random variable, as well as

F(m^{l},P¹)=(A(m^{l},P^{l})+exp−Q(m^{l},P^{l})),

in which A and Q may again be estimated.

The entries of the secondary diagonals of the expected gradient are zero and the diagonal entries are the expectation of the Heaviside function:

$$diag ( {𝔼}_{{x}^{l}} [ \frac{\partial {g}^{l + 1}}{\partial {x}^{l}} ] ) = Φ ( {m}^{l} \text{/} \sqrt{diag ( {P}^{l} )} ) .$$

In the case of dropout, a multivariate variable z∈ [symbol] ^{D}^{ₗ} is drawn (i.e., sampled) from a Bernoulli distribution zᵢ˜Bernoulli(ρ) independently for each activation channel and the non-linearity x^{l+1}=(Z⊙x^{l})/ρ is used, ‘⊙’ denoting the Hadamard multiplication and rescaling being carried out with ρ in order to obtain the expected value. The mean and the covariance of the output may be estimated by

$${m}^{l + 1} = {m}^{l} , \\ {P}^{l + 1} = {P}^{l} + diag ( \frac{q}{p} ( {P}^{l} + ( {m}^{l} ) {( {m}^{l} )}^{T} ) ) .$$

The expected gradient is equal to the identity

[symbol]

ₓ_{^{l}}[∂g^{l+1}/∂χ^{l}]=I

Dropout permits the components of an input x˜ρ(x) for any distribution ρ(x) to be approximately de-correlated, since diag(P^{l+1})>diag(P^{l}) on the basis of diag(P^{l}+(m^{l})(m^{l})^{T})>0 (in each case viewed component-wise). However, the entries outside of the diagonals may be unequal to zero, so that only an approximate de-correlation is carried out. If an approximately de-correlated output of a dropout layer x^{l+1} is processed by an affine transformation, it is assumed that the following output x^{l+2} corresponds to a sum of independently distributed random variables and therefore (according to the central limit theorem), is accepted as Gaussian-distributed.

For each k and neural drift network 201, the moments mₖ,Pₖ are thus used as moments mₖ⁰,Pₖ⁰ of input 203 of neural drift network 201, and from them, the moments mₖ¹,Pₖ¹, mₖ²,Pₖ², mₖ³,Pₖ³ of outputs 204, 205, 206 of the layers are determined according to the rules above. They are utilized to determine the expected value and covariance 207 as well as to determine expected gradient 208.

For diffusion network 202, in addition, [symbol] [L_{ϕ}] and Cov(L_{ϕ},L_{ϕ}) are determined, and from all of these results 209, the moments mₖ₊₁,Pₖ₊₁ for the next instant k+1 are determined.

In the following, an algorithm is indicated for training an NSDE in pseudo-code utilizing a training data record [symbol] .

```
Input: f_{θ}, L_{ϕ}, [symbol]
Output: Optimized θ, ϕ
So long as no convergence yet exists
  {(\hat{x}₁⁽ⁿ⁾, \hat{t}₁⁽ⁿ⁾), . . . , (\hat{x}_{K}_{ₙ}⁽ⁿ⁾, \hat{t}_{K}_{ₙ}⁽ⁿ⁾)} ~ [symbol]   (Drawing a training
  trajectory from the training data record)
  m₁ = \hat{x}₁⁽ⁿ⁾, P₁ = Iϵ (Gaussian approximation of a Dirac
distribution)
  m_{1:K}, P_{1:K} = DNSDE_Stein(m₁, P₁, t_{1:K}⁽ⁿ⁾)
  $θ , ϕ = {argmax}_{θ , ϕ} {\sum }_{k = 2}^{K} log 𝒩 ( {\hat{x}}_{k}^{( n )} \vert {m}_{k} , {P}_{k} ) ( MLE )$
Output θ, ϕ
```

The result of the MLE for a training trajectory is used to adjust the previous estimation of θ, ϕ, until a convergence criterion is satisfied, e.g., θ, ϕ change only a little (or alternatively, a maximum number of iterations is reached).

The function DNSDE_Stein reads as follows in pseudo-code

DNSDE_Stein (m₁, P₁, t_{1:K})
for k ← 1:K −1
m_{f}, P_{f}, J = DriftMoments&Jac (mₖ, Pₖ)
m_{L}, P_{L} = DiffusionMoments (mₖ, Pₖ)
m_{k + 1} = mₖ + m_{f}Δt)
p_{xf} = PₖJ
P_{L,centered} = PL + m_{L}m_{L}^{T} ⊙ I
P_{k + 1} = Pₖ + P_{f}Δt²
P_{k + 1} = P_{k + 1} + (P_{xf} + P_{xf}^{T} + P_{L,centered})Δt

The fourth line in the “for” loop is the use of the lemma of Stein. The following line determines [symbol] [L_{ϕ}L_{ϕ}^{T}(χₖ, tₖ)]

The function Driftmoments&Jac reads as follows in pseudo-code

Driftmoments&Jac (m, P)
J = I
for layer in f_{θ}
Jᵢ = layer.expected gradient (m, P)
J = JᵢJ (Chain rule in forward mode)
m, P = layer.next_moments (m, P)
Give back m, P, J

The function DiffusionMoments reads as follows in pseudo-code

DiffusionMoments (m, P)
for layer in L_{ϕ}
m, P = layer.next_moments (m, P)
P = P ⊙ I (Set diagonal elements to zero)
Give back m, P

In the pseudocode above, the moments (from the starting instant k=1 up to the final instant k=K) and the covariances (from the starting instant k=1 up to the final instant k=K) are denoted by m_{1:K} and P_{1:K} respectively. The moments of the starting instant are m₁ and P₁. In the algorithm above, P₁≈I∈ and m₁=\hat{x}₁⁽ⁿ⁾ are used in order to condition to the observed initial state \hat{x}₁⁽ⁿ⁾ (for the nth training data record). In this case, ∈ is a small number, e.g., ∈=10⁻⁴. In the example above, the output matrix of the diffusion function L_{ϕ}(x) is diagonal and its second moment is likewise diagonal. With the aid of LMM, the functions DriftMoments&Jac and DiffusionMoments estimate the first two moments of the output of drift network 201 and of diffusion network 202 for an input with the moments such as the two functions obtain via their arguments. In addition, in this example, it is assumed that neural networks 201, 202 are constructed in such a way that ReLU activations, dropout layers and affine transformations alternate, so that the output of the affine transformation is approximately normally distributed. In the case of the evaluation of DriftMoments&Jac, the expected gradient [symbol] [∇ₓg(x)] is estimated in the forward mode. For dropout layers and affine transformations, the expected gradient is independent of the distribution of the input. Only in the case of a ReLU activation is the expected gradient dependent on the input distribution (which is approximately a normal distribution).

In the pseudo-code above, a class layer is used, of which it is assumed that it has the functions expected_gradient and next_moments which implement the equations, indicated above for the various layers, for the moments of the output of the layer and of the expected gradient.

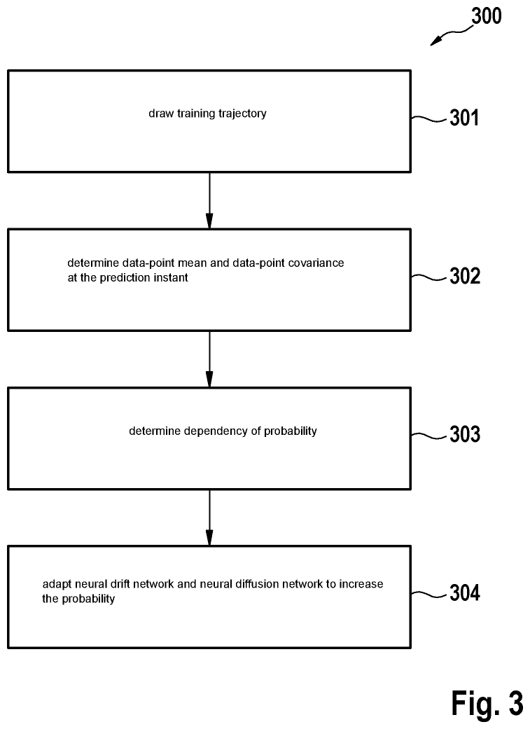

In summary, according to various specific embodiments, a method is provided as represented in FIG. 3.

FIG. 3 shows a flowchart 300 which illustrates a method for training the neural drift network and the neural diffusion network of a neural stochastic differential equation.

In 301, a training trajectory is drawn (sampled, e.g., selected randomly) from training sensor data, the training trajectory having a training data point for each of a sequence of prediction instants.

In 302, starting from the training data point which the training trajectory contains for a starting instant, the data-point mean and the data-point covariance at the prediction instant are determined for each prediction instant of the sequence of prediction instants.

This is accomplished by determining from the data-point mean and the data-point covariance of one prediction instant, the data-point mean and the data-point covariance of the next prediction instant by
Determining the expected values of the derivatives of each layer of the neural drift network according to their input data;
Determining the expected value of the derivative of the neural drift network according to its input data from the ascertained expected values of the derivatives of the layers of the neural drift network; and
Determining the data-point mean and the data-point covariance of the next prediction instant from the ascertained expected value of the derivative of the neural drift network according to its input data.

In 303, a dependency of the probability that the data-point distributions of the prediction instants—which are given by the ascertained date-point means and the ascertained data-point covariances—will supply the training data points at the prediction instants, on the weights of the neural drift network and of the neural diffusion network is determined.

In 304, the neural drift network and the neural diffusion network are adapted to increase the probability.

In other words, according to various specific embodiments, the moments of the distribution of the data points at the various time steps are determined by utilizing the expected values of the derivatives of the neural networks (drift network and diffusion network). These expected values of the derivatives are initially determined layer-wise and are then combined to form the expected values of the derivatives of the neural networks.

According to various specific embodiments, the moments of the distributions of the data points at the various time steps are then determined by layer-wise (e.g., recursive) moment matching. Simply put, according to various specific embodiments, the moments of the distributions of the data points (and consequently the uncertainty of the data points) are propagated through the layers and via time steps.

This is carried out for training data, and the parameters of the neural networks (weights) are optimized with the aid of Maximum Likelihood Estimation, for example.

The trained neural stochastic differential equation may be used to control a robot device.

A “robot device” may be understood to be any physical system (having a mechanical part whose movement is controlled), such as a computer-controlled machine, a vehicle, a household appliance, a power tool, a manufacturing machine, a personal assistant or an access control system.

The control may be carried out based on sensor data. This sensor data (and sensor data contained accordingly in the training data) may be from various sensors such as video, radar, LiDAR, ultrasonic, movement, acoustic, thermal image, etc., for example, sensor data concerning system states as well as configurations. The sensor data may be available in the form of (e.g., scalar) time series.

Specific embodiments may be used especially to train a machine learning system and to control a robot autonomously in order to accomplish different manipulation tasks under various scenarios. In particular, specific embodiments are usable for controlling and monitoring the execution of manipulation tasks, e.g., in assembly lines. For instance, they are able to be integrated seamlessly into a traditional GUI (graphical user interface) for a control process.

For example, in the case of a physical or chemical process, the trained neural stochastic differential equation may be used to predict sensor data e.g., a temperature or a material property, etc.

In such a context, specific embodiments may also be used for detecting anomalies. For example, an OOD (Out of Distribution) detection may be carried out for time series. To that end, for instance, with the aid of the trained neural stochastic differential equation, a mean and a covariance of a distribution of data points (e.g., sensor data) are predicted and it is determined whether measured sensor data follow this distribution. If the deviation is too great, this may be viewed as an indication that an anomaly is present and, for example, a robot device may be controlled accordingly (e.g., an assembly line may be brought to a stop).

The training data record may be constructed depending on the application case. Typically it includes a multitude of training trajectories which, for instance, contain the time characteristics of specific sensor data (temperature, speed, position, material property, . . . ). The training data records may be generated by experiments or by simulations.

According to one specific embodiment, the method is computer-implemented.

Although the present invention was presented and described specifically with reference to particular specific embodiments, it should be understood by those familiar with the field of expertise that numerous modifications may be made with respect to design and details without departing from the essence and scope of the present invention.

What is claimed is:

1. A method for training a neural drift network and a neural diffusion network of a neural stochastic differential equation, the method comprising the following steps:
drawing a training trajectory from training sensor data, the training trajectory having a training data point for each prediction instant of a sequence of prediction instants;
starting from a training data point which the training trajectory includes for a starting instant of the sequence of prediction instants, determining a data-point mean and a data-point covariance at the prediction instant for each prediction instant of the sequence of prediction instants by ascertaining from the data-point mean and the data-point covariance of one prediction instant, the data-point mean and the data-point covariance of a next prediction instant by:
determining expected values of derivatives of each layer of the neural drift network according to its input data;
determining an expected value of a derivative of the neural drift network according to its input data from the determined expected values of the derivatives of the layers of the neural drift network; and
determining the data-point mean and the data-point covariance of the next prediction instant from the determined expected value of the derivative of the neural drift network according to its input data;
determining a dependency of the probability that data-point distributions of the prediction instants, which are given by the determined date-point means and the determined data-point covariances, will supply the training data points at the prediction instants, on weights of the neural drift network and of the neural diffusion network; and
adapting the neural drift network and the neural diffusion network to increase the probability.

2. The method as recited in claim 1, wherein the determination from the data-point mean and the data-point covariance of one prediction instant, the data-point mean and the data-point covariance of the next prediction instant includes:
determining, for the prediction instant, the mean and the covariance of an output of each layer of the neural drift network starting from the data-point mean and the data-point covariance of the prediction instant; and
determining the data-point mean and the data-point covariance of the next prediction instant from the data-point means and data-point covariances of the layers of the neural drift network determined for the prediction instant.

3. The method as recited in claim 1, wherein the determination from the data-point mean and the data-point covariance of one prediction instant, the data-point mean and the data-point covariance of the next prediction instant includes:
determining, for the prediction instant, the mean and the covariance of an output of each layer of the neural diffusion network starting from the data-point mean and the data-point covariance of the prediction instant; and
determining the data-point mean and the data-point covariance of the next prediction instant from the data-point means and data-point covariances of the layers of the neural diffusion network ascertained for the prediction instant.

4. The method as recited in claim 1, wherein the expected value of the derivative of the neural drift network according to its input data is determined by multiplying derivatives of the determined expected values of the derivatives of the layers of the neural drift network.

5. The method as recited in claim 1, wherein the determination of the data-point covariance of the next prediction instant from the data-point mean and the data-point covariance of one prediction instant includes:
determining a covariance between input and output of the neural drift network for the prediction instant by multiplying the data-point covariance of the prediction instant by the expected value of the derivative of the neural drift network according to its input data; and
determining the data-point covariance of the next prediction instant from the covariance between input and output of the neural drift network for the prediction instant.

6. The method as recited in claim 1, further comprising:
forming the neural drift network and the neural diffusion network from ReLU activations, dropout layers, and layers for affine transformations.

7. The method as recited in claim 6, further comprising:
forming the neural drift network and the neural diffusion network so that the ReLU activations, the dropout layers, and the layers for affine transformations alternate in the neural drift network.

8. A method for controlling a robot device, comprising the following steps:
training a neural drift network and a neural diffusion network of a neural stochastic differential equation, the training including:
drawing a training trajectory from training sensor data, the training trajectory having a training data point for each prediction instant of a sequence of prediction instants;
starting from a training data point which the training trajectory includes for a starting instant of the sequence of prediction instants, determining a data-point mean and a data-point covariance at the prediction instant for each prediction instant of the sequence of prediction instants by ascertaining from the data-point mean and the data-point covariance of one prediction instant, the data-point mean and the data-point covariance of a next prediction instant by:
determining expected values of derivatives of each layer of the neural drift network according to its input data;
determining an expected value of a derivative of the neural drift network according to its input data from the determined expected values of the derivatives of the layers of the neural drift network; and
determining the data-point mean and the data-point covariance of the next prediction instant from the determined expected value of the derivative of the neural drift network according to its input data;
determining a dependency of the probability that data-point distributions of the prediction instants, which are given by the determined date-point means and the determined data-point covariances, will supply the training data points at the prediction instants, on weights of the neural drift network and of the neural diffusion network; and
adapting the neural drift network and the neural diffusion network to increase the probability;
measuring sensor data which characterize a state of the robot device and/or one or more objects in an area surrounding the robot device;
supplying the sensor data to the stochastic differential equation to produce a regression result; and
controlling the robot device utilizing the regression result.

9. A training device configured to train a neural drift network and a neural diffusion network of a neural stochastic differential equation, the training device configured to:
draw a training trajectory from training sensor data, the training trajectory having a training data point for each prediction instant of a sequence of prediction instants;
starting from a training data point which the training trajectory includes for a starting instant of the sequence of prediction instants, determine a data-point mean and a data-point covariance at the prediction instant for each prediction instant of the sequence of prediction instants by ascertaining from the data-point mean and the data-point covariance of one prediction instant, the data-point mean and the data-point covariance of a next prediction instant by:
determining expected values of derivatives of each layer of the neural drift network according to its input data;
determining an expected value of a derivative of the neural drift network according to its input data from the determined expected values of the derivatives of the layers of the neural drift network; and
determining the data-point mean and the data-point covariance of the next prediction instant from the determined expected value of the derivative of the neural drift network according to its input data;
determine a dependency of the probability that data-point distributions of the prediction instants, which are given by the determined date-point means and the determined data-point covariances, will supply the training data points at the prediction instants, on weights of the neural drift network and of the neural diffusion network; and
adapt the neural drift network and the neural diffusion network to increase the probability.

10. A control device for a robot device, the control device configured to:
measure sensor data which characterize a state of the robot device and/or one or more objects in an area surrounding the robot device;
supply the sensor data to a trained stochastic differential equation to produce a regression result; and
control the robot device utilizing the regression result;
wherein the stochastic differential equation is trained by a training device which is configured to train a neural drift network and a neural diffusion network of the neural stochastic differential equation, the training device configured to:
draw a training trajectory from training sensor data, the training trajectory having a training data point for each prediction instant of a sequence of prediction instants;
starting from a training data point which the training trajectory includes for a starting instant of the sequence of prediction instants, determine a data-point mean and a data-point covariance at the prediction instant for each prediction instant of the sequence of prediction instants by ascertaining from the data-point mean and the data-point covariance of one prediction instant, the data-point mean and the data-point covariance of a next prediction instant by:
determining expected values of derivatives of each layer of the neural drift network according to its input data;
determining an expected value of a derivative of the neural drift network according to its input data from the determined expected values of the derivatives of the layers of the neural drift network; and
determining the data-point mean and the data-point covariance of the next prediction instant from the determined expected value of the derivative of the neural drift network according to its input data;
determine a dependency of the probability that data-point distributions of the prediction instants, which are given by the determined date-point means and the determined data-point covariances, will supply the training data points at the prediction instants, on weights of the neural drift network and of the neural diffusion network; and
adapt the neural drift network and the neural diffusion network to increase the probability.

11. A non-transitory computer-readable storage medium on which are stored program instructions for training a neural drift network and a neural diffusion network of a neural stochastic differential equation, the stored program instructions, when executed by one or more processors, causing the one or more processors to perform the following steps:
drawing a training trajectory from training sensor data, the training trajectory having a training data point for each prediction instant of a sequence of prediction instants;
starting from a training data point which the training trajectory includes for a starting instant of the sequence of prediction instants, determining a data-point mean and a data-point covariance at the prediction instant for each prediction instant of the sequence of prediction instants by ascertaining from the data-point mean and the data-point covariance of one prediction instant, the data-point mean and the data-point covariance of a next prediction instant by:
determining expected values of derivatives of each layer of the neural drift network according to its input data;
determining an expected value of a derivative of the neural drift network according to its input data from the determined expected values of the derivatives of the layers of the neural drift network; and
determining the data-point mean and the data-point covariance of the next prediction instant from the determined expected value of the derivative of the neural drift network according to its input data;
determining a dependency of the probability that data-point distributions of the prediction instants, which are given by the determined date-point means and the determined data-point covariances, will supply the training data points at the prediction instants, on weights of the neural drift network and of the neural diffusion network; and
adapting the neural drift network and the neural diffusion network to increase the probability.
